(19) United States
(12) Patent Application Publication
(10) Pub. No.: US 2018/0207789 A1
(43) Pub. Date: Jul. 26, 2018

(54) TOOL BOX

(71) Applicant: Yu-Hua OU, Taichung City (TW)

(72) Inventor: Yu-Hua OU, Taichung City (TW)

(21) Appl. No.: 15/411,253

(22) Filed: Jan. 20, 2017

(51) Int. Cl. B25H 3/00; B25H 3/06

(52) U.S. Cl. CPC B25H 3/003; B25H 3/06

(57) ABSTRACT

The tool box is adapted for receiving at least one socket. The socket has a sleeve hole. The sleeve hole has a minimum internal diameter defined as d. The tool box includes a main body. The main body has a protrusion which is hollow. The protrusion is made of plastic and includes a top portion and a body portion. The protrusion has a maximum external diameter defined as D. D is 1.065 times to 1.085 times d. The protrusion is adapted for the socket to sleeve onto with the sleeve hole so that the socket is positioned on the main body.

### BACKGROUND OF THE INVENTION

### Field of the Invention

The present invention relates to a tool box.

### Description of the Prior Art

Conventional tool boxes for sockets are shown in patents TW M299064 and TW 533972. The tool box is manufactured by a foamed piece with recess. The socket can be inserted into the recess and be positioned by the foamed material.

However, tool boxes are often brought or placed reversely. Thereby, the sockets embedded in the foamed piece may fall down easily. Besides, after using for a long time, the recess of the foamed material may be enlarged to make it difficult to position the sockets.

Some tool boxes have protrusions on the side walls of the recess, so the socket can be positioned by the protrusions to be difficult to detach. However, it is not quite easy to position the socket, and the socket may still fall down when inclining.

### SUMMARY OF THE INVENTION

The main object of the present invention is to provide a tool box which is able to position the socket firmly and allows the socket to be easily detached.

To achieve the above and other objects, a tool box of the present invention is adapted for receiving at least one socket. The socket has a sleeve hole. The sleeve hole has a minimum internal diameter defined as d. The tool box includes a main body. The main body has a protrusion which is hollow. The protrusion is made of plastic and includes a top portion and a body portion. The protrusion has a maximum external diameter defined as D. D is 1.65 times to 1.85 times d. The protrusion is adapted for the socket to sleeve onto with the sleeve hole so that the socket is positioned on the main body.

Thereby, the tool box of the present invention can position the socket firmly and can be detached easily. In addition, the tool box hardly damages.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a partial cross-section drawing of the present invention;

FIG. 3 is a cross-section drawing of a protrusion of the present invention;

FIG. 4 is a partial enlargement of FIG. 3;

FIG. 5 is a cross-section drawing of a protrusion of a second embodiment of the present invention;

FIG. 6 is a partial enlargement of FIG. 5.

### DETAILED DESCRIPTION OF THE PREFERRED EMBODIMENTS

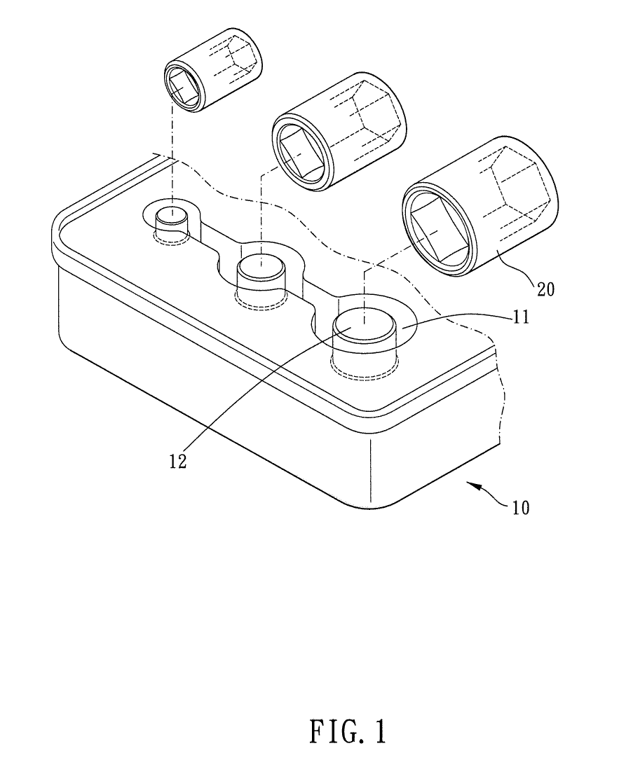

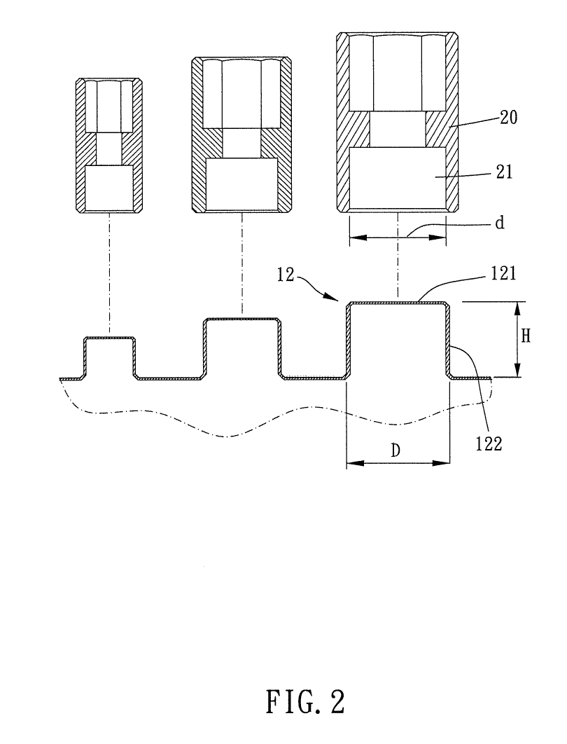

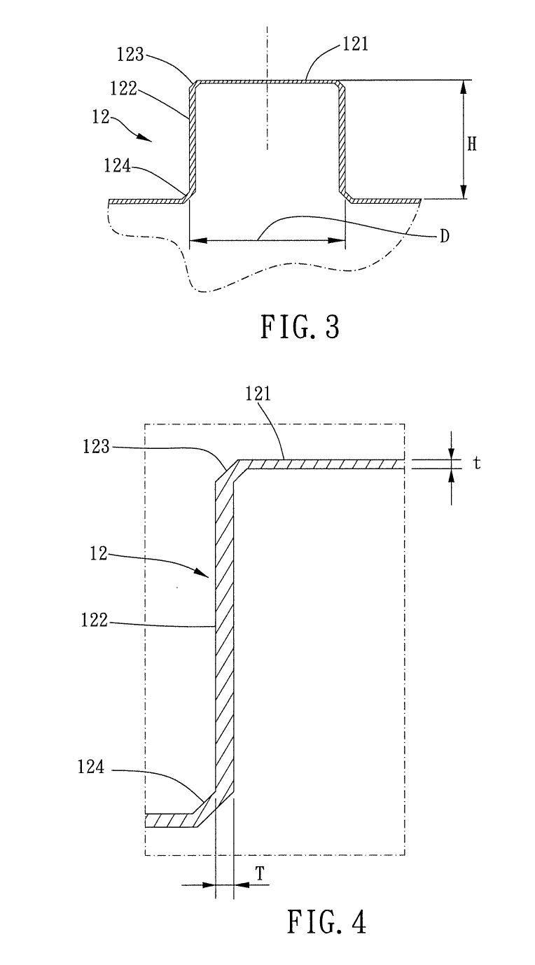

Please refer to FIG. 1 to FIG. 4, the tool box of the present invention includes at least one socket 20 and a main body 10. The socket 20 has a sleeve hole 21. The minimum internal diameter of the sleeve hole 21 is defined as d. The main body 10 is formed with at least one protrusion 12 which is hollow but not open. The protrusion 12 is made of plastic and includes a top portion 121 and a body portion 122. The maximum external diameter of the protrusion 12 is defined as D. D is 1.65 times d to 1.85 times d. The protrusion 12 is adapted for the socket 20 to sleeve onto with the sleeve hole 21 so as to position the socket 20 on the main body 10.

In addition, the thickness of the body portion 122 of the protrusion 12 is defined as T, and the relationship between T and d is defined by an equation of T=0.0315d+0.1. The height of the protrusion 12 is defined as H, and H is 0.8 times d to 0.9 times d. The thickness of the top portion 121 of the protrusion 12 is defined as t, and t is smaller than T.

In the present embodiment, for the ¼″ socket (d=6.35 mm), D is ranged between 6.75 mm to 6.85 mm, preferably 6.8 mm. T is 0.3 mm, and H is ranged between 5.4 mm to 5.6 mm, preferably 5.5 mm. For the ⅜″ socket (d=9.525 mm), D is ranged between 10.25 mm to 10.35 mm, preferably 10.3 mm. T is 0.4 mm, and H is ranged between 7.9 mm to 8.1 mm, preferably 8 mm. For ½″ socket (d=12.7 mm), D is ranged between 13.55 mm to 13.65 mm, preferably 13.6 mm. T is 0.5 mm, and H is ranged between 10.4 mm to 10.6 mm, preferably 10.5 mm.

Specifically, the protrusion 12 is shaped by blow molding. The main body 10 is formed with at least one recess 11. The protrusion 12 is formed on the bottom of the recess 11. A first chamfer 123 is formed between the top portion 121 and the body portion 122 of the protrusion 12. A second chamfer 124 is formed between the body portion 122 of the protrusion 12 and the bottom portion of the recess 11. The first chamfer 123 facilitates the protrusion 12 to insert into the sleeve hole 21 of the socket 20, and the second chamfer 124 enhances the connection between the protrusion 12 and the bottom of the recess 11 to prevent the protrusion 12 from breaking.

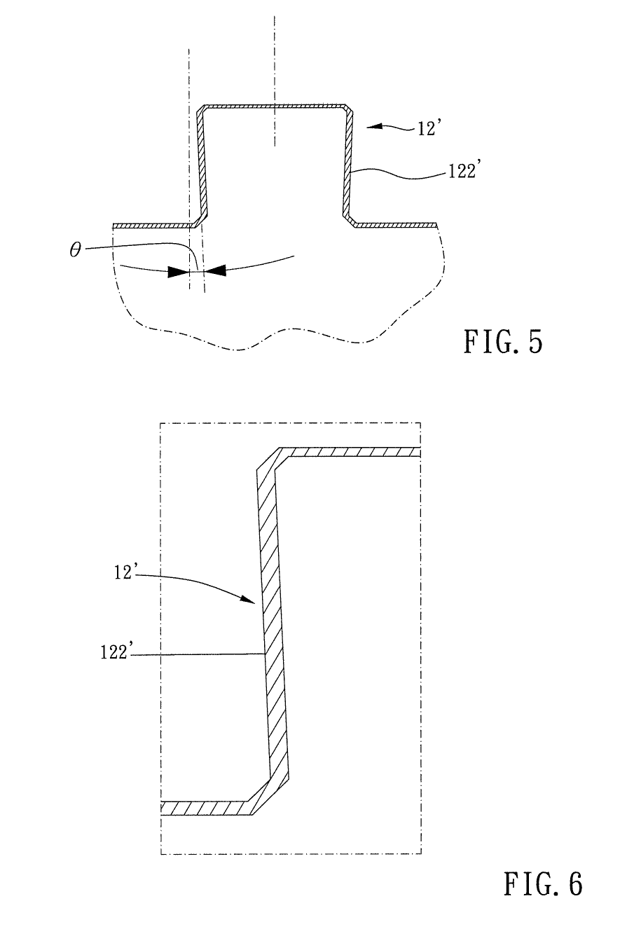

Please refer to FIG. 5 and FIG. 6 for another embodiment of the present invention, the external diameter of the body portion 122′ of the protrusion 12′ is tapered from an end near the top portion toward an end remote from the top portion to position the socket more thinly.

Practically, the main body can be shaped by blow molding as a single piece. That is, the recess and the protrusion are both shaped by blow molding. Besides, the external diameter of the protrusion is slightly larger than the internal diameter of the sleeve hole of the socket, and the plastic material has slight elasticity so that the socket can be positioned on the protrusion. However, the external diameter of the protrusion is not too large so that the socket may not be difficult to be detached. In addition, the top portion of the protrusion is thinner than the body portion, so the elasticity of the protrusion along the radial direction is larger, and the body portion still has enough structure strength.

1. A tool box, adapted for receiving at least one socket, the socket having a sleeve hole, the sleeve hole having a minimum internal diameter defined as d, the tool box including:
a main body, having a protrusion which is hollow, the protrusion being made of plastic and including a top portion and a body portion, the protrusion having a maximum external diameter defined as D, D being 1.065 times to 1.085 times d, the protrusion being adapted for the socket to sleeve onto with the sleeve hole so that the socket is positioned on the main body;
wherein a thickness of the body portion of the protrusion is defined as T, a relationship between T and d is defined as an equation of T=0.0315d+0.1;
wherein a thickness of the top portion of the protrusion is defined as t, t is smaller than T.

2. The tool box of claim 1, wherein a first chamfer is formed between the top portion and the body portion of the protrusion.

3. The tool box of claim 1, wherein the main body is formed with at least one recess, the protrusion is formed on a bottom of the at least one recess.

4. The tool box of claim 3, wherein a second chamfer is formed between the bottom of the at least one recess and the body portion of the protrusion.

5. (canceled)

6. The tool box of claim 51, wherein a height of the protrusion is defined as H, H is 0.8 times to 0.9 times d.

7. The tool box of claim 6, wherein d is 6.35 mm, D is ranged between 6.75 mm to 6.85 mm, T is 0.3 mm, H is ranged between 5.4 mm to 5.6 mm.

8. The tool box of claim 7, wherein D is 6.8 mm.

9. The tool box of claim 6, wherein d is 9.525 mm, D is ranged between 10.25 mm to 10.35 mm, T is 0.4 mm, H is ranged between 7.9 mm to 8.1 mm.

10. The tool box of claim 9, wherein D is 10.3 mm.

11. The tool box of claim 6, wherein d is 12.7 mm, D is ranged between 13.55 mm to 13.65 mm, T is 0.5 mm, H is ranged between 10.4 mm to 10.6 mm.

12. The tool box of claim 11, wherein D is 13.6 mm.

13. (canceled)

14. The tool box of claim 1, wherein an external diameter of the body portion of the protrusion is tapered from an upper end toward a lower end of the body portion.

15. The tool box of claim 1, wherein the protrusion is shaped by blow molding.

16. A tool box, including:
at least one socket, having a sleeve hole, a minimum internal diameter of the sleeve hole being defined as d;
a main body, having a protrusion which is hollow, the protrusion being made of plastic and including a top portion and a body portion, the protrusion having a maximum external diameter defined as D, D being 1.065 times to 1.085 times d, the protrusion being adapted for the socket to sleeve onto with the sleeve hole so that the socket is positioned on the main body;
wherein a thickness of the body portion of the protrusion is defined as T, a relationship between T and d is defined as an equation of T=0.0315d+0.1;
wherein a thickness of the tots portion of the protrusion is defined as t, t is smaller than T.
